(19) United States
(12) Patent Application Publication
(10) Pub. No.: US 2019/0368381 A1
(43) Pub. Date: Dec. 5, 2019

(54) Combustion System Deflection Mitigation Structure

(71) Applicant: General Electric Company, Schenectady, NY (US)

(72) Inventors: Anthony Paul Greenwood, Kings Mills, OH (US); Brian Michael Dixon, West Chester, OH (US); Nestor Martinez Toro, Hamilton, OH (US); David Fasig, Liberty Township, OH (US); Kimbra Chaplin, Melbourne, KY (US); Ashish Narayan, Bangalore (IN); Jeremy Kevin Payne, Cincinnati, OH (US)

(21) Appl. No.: 15/992,513

(22) Filed: May 30, 2018

(51) Int. Cl. F01D 25/26; F01D 25/24; F02C 7/22

(52) U.S. Cl. CPC F01D 25/26; F01D 25/243; F02C 7/22; F23R 3/002; F05D 2220/32; F05D 2260/232; F05D 2240/35; F05D 2240/14

(57) ABSTRACT

A turbine engine including a first outer casing and a second outer casing coupled together at a flange. The first outer casing and the second outer casing are together disposed around a core engine. An inner casing assembly is extended from the flange between the first outer casing and the second outer casing. A flow circuit is defined between the first outer casing, the inner casing assembly, and the second outer casing.

### FIELD

The present subject matter relates generally to structures for mitigating deflection or displacement of a hot section casing relative to a surrounding casing.

### BACKGROUND

Gas turbine engines include hot sections generally defined by portions of the engine at and downstream of a combustion section. Typical combustion sections incorporate one or more fuel nozzles coupled to an outer casing whose function is to introduce liquid or gaseous fuel into an air flow stream so that it can atomize and burn. General gas turbine engine combustion design criteria include optimizing the mixture and combustion of a fuel and air to produce high-energy combustion while minimizing emissions such as carbon monoxide, carbon dioxide, nitrous oxides, and unburned hydrocarbons, as well as minimizing combustion tones due, in part, to pressure oscillations during combustion.

However, as an engine operates and generates increased heat, thermal gradients between the hot section and an upstream cold section, or between radially outer casings and inner casing, cause deflections relative to one another. Such deflections alter clearances or axial overlaps between rotary and static components in the hot section. Such deflections may alternatively, or additionally, adversely affect fuel nozzle immersions. Such altered immersions may result in combustion section auto-ignition or otherwise adversely affect emissions, performance, or operability of the combustion section and engine.

As such, there is a need for structures and methods that may reduce thermal gradients in the hot section that may mitigate deflections between casings or between casings and rotating structures.

### BRIEF DESCRIPTION

Aspects and advantages of the invention will be set forth in part in the following description, or may be obvious from the description, or may be learned through practice of the invention.

The present disclosure is directed to a turbine engine including a first outer casing and a second outer casing coupled together at a flange. The first outer casing and the second outer casing are together disposed around a core engine. An inner casing assembly is extended from the flange between the first outer casing and the second outer casing. A flow circuit is defined between the first outer casing, the inner casing assembly, and the second outer casing.

In one embodiment, the flow circuit is defined from radially inward of the outer casing, wherein a flow of compressed air is provided through the flow circuit.

In another embodiment, the inner casing assembly, the first outer casing, the second outer casing, or combinations thereof define a groove through which the flow circuit is defined.

In various embodiments, the first outer casing and the inner casing assembly together define a first cavity therebetween, wherein the first cavity defines a first pressure. In one embodiment, the second outer casing and the inner casing assembly together define a second cavity therebetween, wherein the second cavity defines a second pressure higher than the first pressure. In another embodiment, the flow circuit is extended from the second cavity to the first cavity. In still another embodiment, the second cavity defines a diffuser cavity of a combustion section. In yet another embodiment, the flow circuit provides a flow of fluid from the second cavity to the first cavity. In still yet another embodiment, the flow circuit is extended radially into the flange from the second cavity, axially into the flange, and radially through the flange into the first cavity.

In still various embodiments, the flow circuit defines a plurality of discrete openings. In one embodiment, the engine defines a plurality of the flow circuit each defining a discrete opening, wherein the plurality of the flow circuit is disposed in adjacent circumferential arrangement.

In one embodiment, the inner casing assembly defines an inner diffuser case.

In another embodiment, the first outer casing defines a compressor case.

In yet another embodiment, the second outer casing defines an outer diffuser case.

In still another embodiment, one or more of a combustor liner or a turbine nozzle is coupled to the inner casing assembly.

In still yet another embodiment, a fuel nozzle is coupled to the second outer casing.

In one embodiment, the flow circuit defines a tuned cross sectional area based at least on a desired thermal gradient between the inner casing assembly and the first outer casing and second outer casing.

In another embodiment, the flow circuit is extended at least partially along a circumferential direction relative to an axial centerline of the engine.

In still another embodiment, the turbine engine further includes a compressor section in which the first outer casing is defined substantially around the compressor section.

In still yet another embodiment, the turbine engine further includes a combustion section in which the second outer casing is defined substantially around the combustion section.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic cross sectional view of an exemplary gas turbine engine according to an aspect of the present disclosure;

FIG. 2 is an axial cross sectional view of an exemplary embodiment of a portion of the exemplary engine shown in FIG. 1;

FIG. 3 is a detailed axial cross sectional view of an exemplary embodiment of a flow circuit at FIG. 2; and

FIG. 4 is a cross sectional view at Section 4-4 of FIG. 3 depicting an exemplary embodiment of the flow circuit.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first”, “second”, and “third” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

Embodiments of structures for reducing the thermal gradient between an outer casing and an inner portion of an inner casing assembly attached together by a conical portion to reduce or mitigate the relative deflections between the casings, cone, and components attached thereto are generally provided. Components attached to the casings include fuel nozzles, turbine nozzles, and stationary seals. The structures and methods shown and described herein include reducing the thermal gradient between an outer casing and a radially inward inner portion of the inner casing assembly. Providing thermal energy at a flange at the outer casing reduces a thermal gradient between the inner portion of the inner casing assembly (e.g., inward of a combustor liner) and the outer casing. By reducing the thermal gradient, the structures generally provided herein reduce or eliminate deflections that alter clearances or axial overlaps between rotary and static components in the hot section, such as between the inner casing, turbine nozzle and seals surrounding rotary components of the turbine section.

By reducing the relative deflection between the outer casing and the inner casing, relative deflections are reduced between the fuel nozzles (coupled to the outer casing) and the combustion chamber (coupled, at least in part, to the inner casing). The reduced relative deflection between the fuel nozzle and combustion chamber reduces or eliminates changes in fuel nozzle immersions that may mitigate combustion section auto-ignition and/or improve emissions, performance, or operability of the combustion section and engine.

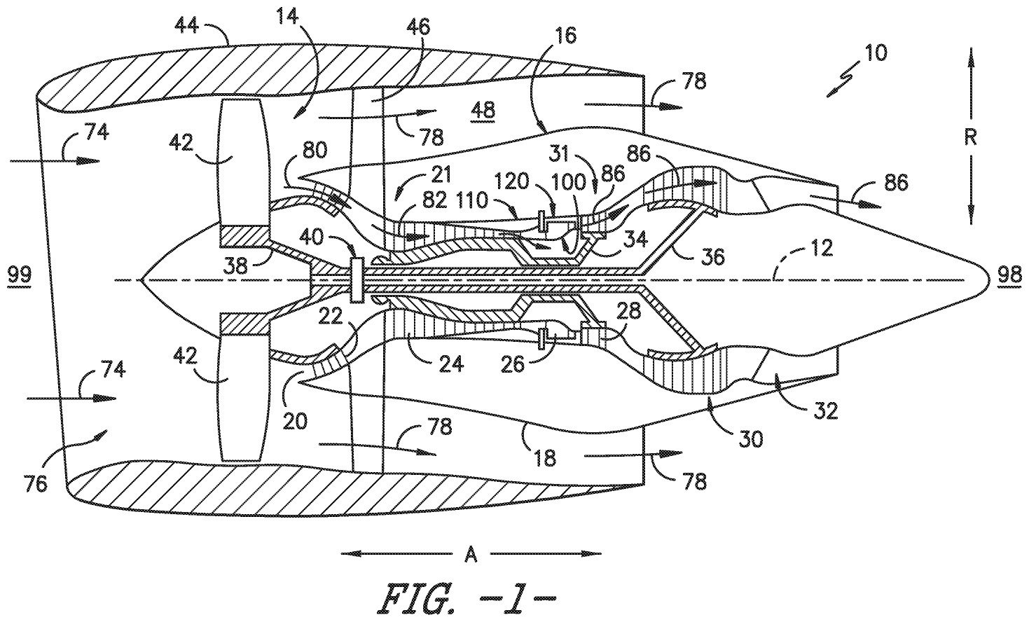

Referring now to the drawings, FIG. 1 is a schematic partially cross-sectioned side view of an exemplary high by-pass turbofan jet engine 10 herein referred to as “engine 10” as may incorporate various embodiments of the present disclosure. Although further described below with reference to a turbofan engine, the present disclosure is also applicable to turbomachinery in general, including turbojet, turboprop, and turboshaft gas turbine engines, including marine and industrial turbine engines and auxiliary power units. As shown in FIG. 1, the engine 10 has a longitudinal or axial centerline axis 12 that extends there through for reference purposes. A reference axial direction A co-directional to the axial centerline axis 12 is provided. A reference radial direction R extended from the axial centerline axis 12 is also provided. The engine 10 further defines a reference upstream end 99 and a downstream end 98 generally indicating an axial direction of flow through the engine 10.

In general, the engine 10 may include a fan assembly 14 and a core engine 16 disposed downstream from the fan assembly 14. The core engine 16 may generally include a substantially tubular outer core casing 18 that defines an annular inlet 20. The outer core casing 18 encases or at least partially forms, in serial flow relationship, a compressor section 21 having a booster or low pressure (LP) compressor 22, a high pressure (HP) compressor 24, a combustion section 26, a turbine section 31 including a high pressure (HP) turbine 28, a low pressure (LP) turbine 30 and a jet exhaust nozzle section 32. The outer core casing 18 may generally include a first outer casing 110 and a second outer casing 120, such as further described below in regard to FIGS. 2-4. The outer core casing 18 further defines an inlet opening 20 through which a flow of air 80 enters the core engine 16.

A high pressure (HP) rotor shaft 34 drivingly connects the HP turbine 28 to the HP compressor 24. A low pressure (LP) rotor shaft 36 drivingly connects the LP turbine 30 to the LP compressor 22. The LP rotor shaft 36 may also be connected to a fan shaft 38 of the fan assembly 14. In particular embodiments, as shown in FIG. 1, the LP rotor shaft 36 may be connected to the fan shaft 38 by way of a reduction gear 40 such as in an indirect-drive or geared-drive configuration. In other embodiments, the engine 10 may further include an intermediate pressure (IP) compressor and turbine rotatable with an intermediate pressure shaft.

As shown in FIG. 1, the fan assembly 14 includes a plurality of fan blades 42 that are coupled to and that extend radially outwardly from the fan shaft 38. An annular fan casing or nacelle 44 circumferentially surrounds the fan assembly 14 and/or at least a portion of the core engine 16. In one embodiment, the nacelle 44 may be supported relative to the core engine 16 by a plurality of circumferentially-spaced outlet guide vanes or struts 46. Moreover, at least a portion of the nacelle 44 may extend over an outer portion of the core engine 16 so as to define a bypass airflow passage 48 therebetween.

FIG. 2 is a cross sectional side view of an exemplary combustion section 26 of the core engine 16 as shown in FIG. 1. As shown in FIG. 2, the combustion section 26 may generally include an annular type combustor assembly 50 having an annular inner liner 52, an annular outer liner 54 and a bulkhead 56 that extends radially between upstream ends of the inner liner 52 and the outer liner 54 respectfully. In other embodiments of the combustion section 26, the combustion assembly 50 may be a can or can-annular type. As shown in FIG. 2, the inner liner 52 is radially spaced from the outer liner 54 with respect to engine centerline 12 (FIG. 1) and defines a generally annular combustion chamber 62 therebetween. In particular embodiments, the inner liner 52 and/or the outer liner 54 may be at least partially or entirely formed from metal alloys or ceramic matrix composite (CMC) materials.

As shown in FIG. 2, the inner liner 52 and the outer liner 54 may be encased within a second outer casing 120. In various embodiments, the liners 52, 54 are coupled to the second outer casing 120 and/or an inner portion 101 of an inner casing assembly 100. An outer flow passage 66 may be defined around the outer liner 54. The inner liner 52 and the outer liner 54 may extend from the bulkhead 56 towards a turbine nozzle or inlet 68 to the HP turbine 28 (FIG. 1) supported between the second outer casing 120 and inner casing 101, thus at least partially defining a hot gas path between the combustor assembly 50 and the HP turbine 28. A fuel nozzle 200 may extend at least partially through the bulkhead 56 and provide a fuel-air mixture 72 to the combustion chamber 62.

During operation of the engine 10, as shown in FIGS. 1 and 2 collectively, a volume of air as indicated schematically by arrows 74 enters the engine 10 through an associated inlet 76 of the nacelle 44 and/or fan assembly 14. As the air 74 passes across the fan blades 42 a portion of the air as indicated schematically by arrows 78 is directed or routed into the bypass airflow passage 48 while another portion of the air as indicated schematically by arrow 80 is directed or routed into the LP compressor 22. Air 80 is progressively compressed as it flows through the LP and HP compressors 22, 24 towards the combustion section 26. As shown in FIG. 2, the now compressed air as indicated schematically by arrows 82 flows across a compressor exit guide vane (CEGV) 67 and through a prediffuser 65 into a head end portion or diffuser cavity 84 of the combustion section 26.

The prediffuser 65 and CEGV 67 condition the flow of compressed air 82 to the fuel nozzle 200. The compressed air 82 pressurizes the diffuser cavity 84. The compressed air 82 enters the fuel nozzle 200 to mix with a fuel 71. The fuel nozzle 200 mixes fuel 71 and air 82 to produce a fuel-air mixture 72 exiting the fuel nozzle 200. After premixing the fuel 71 and air 82 at the fuel nozzle 200, the fuel-air mixture 72 burns in the combustion chamber 62 to generate combustion gases 86 to drive rotation of the rotors at the turbine section 31.

Typically, the LP and HP compressors 22, 24 provide more compressed air to the diffuser cavity 84 than is needed for combustion. Therefore, a second portion of the compressed air 82 as indicated schematically by arrows 82(a) may be used for various purposes other than combustion. For example, as shown in FIG. 2, compressed air 82(a) may be routed into the outer flow passage 66 and an inner passage 64 to provide cooling to the inner and outer liners 52, 54. In addition or in the alternative, at least a portion of compressed air 82(a) may be routed out of the diffuser cavity 84. For example, a portion of compressed air 82(a) may be directed through various flow passages to provide cooling air to the turbine section 31.

Referring back to FIGS. 1 and 2 collectively, the combustion gases 86 generated in the combustion chamber 62 flow from the combustor assembly 50 into the HP turbine 28, thus causing the HP rotor shaft 34 to rotate, thereby supporting operation of the HP compressor 24. As shown in FIG. 1, the combustion gases 86 are then routed through the LP turbine 30, thus causing the LP rotor shaft 36 to rotate, thereby supporting operation of the LP compressor 22 and/or rotation of the fan shaft 38. The combustion gases 86 are then exhausted through the jet exhaust nozzle section 32 of the core engine 16 to provide propulsive thrust.

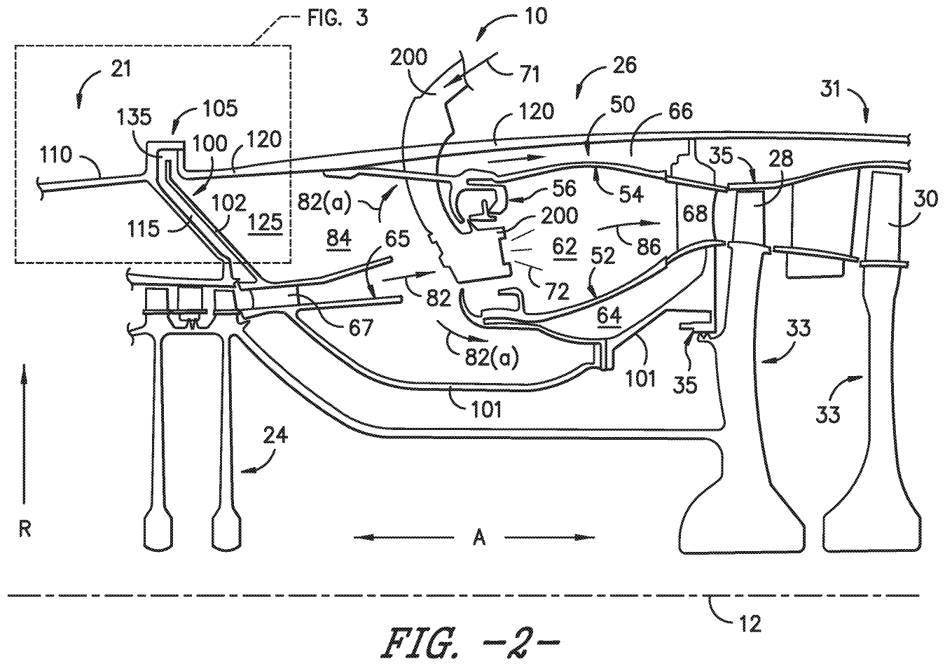

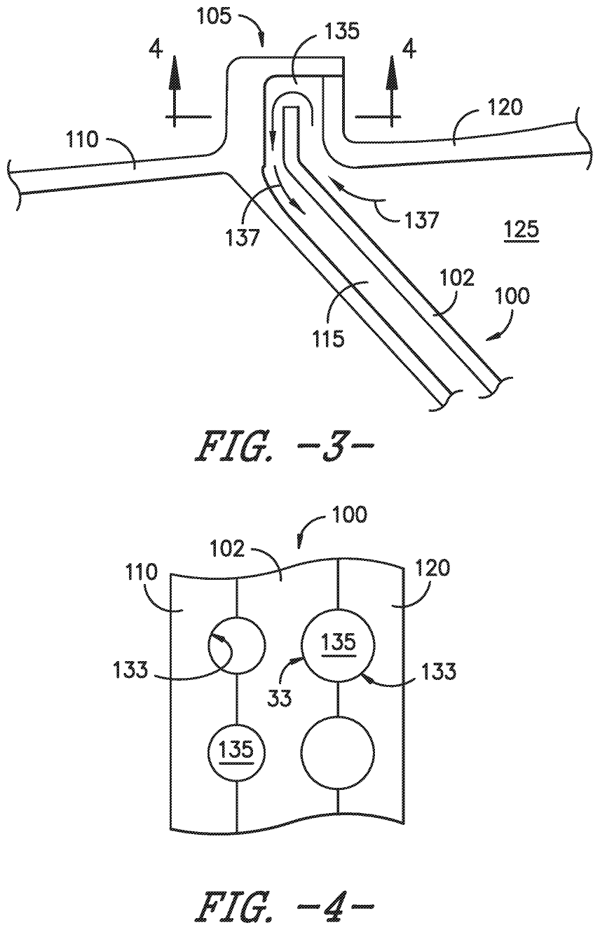

In regard to FIGS. 2-3, exemplary embodiments of the combustion section 26 are generally provided. The combustion section 26 includes the inner casing assembly 100. The inner casing assembly 100 is extended from a flange 105 at which a first outer casing 110 and a second outer casing 120 are together coupled. The first outer casing 110 is extended forward or upstream from the flange 105. The second outer casing 120 is extended aft or downstream from the flange 105. The inner casing assembly 100 may generally be defined at the flange 105 between the first and second outer casings 110, 120. In one embodiment, the inner casing assembly 100 includes a frusto-conical or conical portion 102 coupled to the inner portion 101. The conical portion 102 of the inner casing assembly 100 is coupled to the flange 105 between the outer casings 110, 120.

In various embodiments, the first outer casing 110 and the second outer casing 120 are each disposed around at least a portion of the core engine 16. In one embodiment, the first outer casing 110 may define an outer casing substantially around the compressor section 21. For example, the first outer casing 110 may generally contain, house, or otherwise attach one or more stator or vane assemblies, frames, or other static structures at the compressor section 21. The first outer casing 110 may further contain a rotating section, such as one or more rotating compressor stages, there within.

The second outer casing 120 may define an outer casing substantially around a hot section of the engine 10, such as the combustion section 26 and/or the turbine section 31. In various embodiments, the second outer casing 120 may generally define a pressure vessel or diffuser casing. The second outer casing 120 and the inner casing assembly 100 may together define a second cavity 125. In various embodiments, the second cavity 125 defines the head portion or diffuser cavity 84 such as described in regard to FIG. 2. As another example, the pressure vessel or diffuser casing may define the diffuser cavity 84, the prediffuser 65, and/or the CEGV 67. In still various embodiments, the pressure vessel or diffuser casing may further be defined in conjunction with the inner casing assembly 100. For example, the inner casing assembly 100 may define an inner diameter of the pressure vessel or diffuser casing and the second outer casing 120 may define, at least in part, an outer diameter of the pressure vessel or diffuser casing.

Referring still to FIG. 2, the first outer casing 110 and the inner casing assembly 100 together define a first cavity 115 therebetween. The first cavity 115 may define a compressor cavity or secondary flow cavity of the compressor. The first cavity 115 is defined generally forward of the second cavity 125 defined between the second outer casing 120 and the inner casing assembly 100. The first cavity 115 defines a first pressure different from a second pressure defined at the second cavity 125. In various embodiments, the second pressure defined at the second cavity 125 is generally higher than the first pressure defined at the first cavity 115. In still various embodiments, the inner casing assembly 100, such as the inner portion 101, may further be coupled to an inner diameter of the turbine nozzle or inlet 68. The turbine nozzle or inlet 68 may generally define a static structure.

Referring still to FIG. 2, in conjunction with the detailed view provided in FIG. 3, a flow circuit 135 is defined between the first outer casing 110, the inner casing assembly 100, and the second outer casing 120. More specifically, the flow circuit 135 may be defined between the first outer casing 110, the outer diameter of the inner casing assembly 100 (e.g., outer diameter of the conical portion 102 at the flange 105), and the second outer casing 120. In one embodiment, the flow circuit 135 is at least partially defined at the flange 105 between the first outer casing 110, the outer diameter of the conical portion 102 of the inner casing assembly 100, and the second outer casing 120.

As generally depicted in FIG. 3, the flow circuit 135 is defined from radially inward of the outer casing 110, 120. A flow of fluid, (e.g., compressed air) shown schematically by arrows 137, is provided through the flow circuit 135. For example, in various embodiments, the flow circuit 135 is extended from the second cavity 125 to the first cavity 115. As another example, the flow circuit 135 is extended between the second cavity 125 defining the second pressure to the first cavity 115 defining the first pressure. As such, the flow circuit 135 provides a flow of fluid 137 from the higher pressure second cavity 125 to the lower pressure first cavity 115. As such, the flow circuit 135 enables providing thermal energy to the flange 105 from the relatively warmer flow of fluid 137. Providing such heat transfer at the flange 105 and one or more of the outer casings 110, 120 may reduce a thermal gradient or difference in temperature between the flange 105 and an inner portion 101 of the inner casing assembly 100. Such reduction in the thermal gradient may mitigate relative axial deflection between the outer casings 110, 120 and the inner portion 101 of the inner casing assembly 100. Such reduction in thermal gradient may further mitigate associated adverse effects to fuel nozzle 200 immersion, turbine nozzle 68 displacement (e.g., turbine nozzle rock), and/or seal overlap and clearance 35 relative to rotors and static structures of the turbine section 31.

In various embodiments, the flow circuit 135 is extended radially into the flange 105 from the second cavity 125. The flow circuit 135 may further extend along the axial direction A into the flange 105. The flow circuit 135 may further extend radially through the flange 105 into the first cavity 115. In one embodiment, the flow circuit 135 is further extended at least partially along a circumferential direction relative to the axial centerline 12 of the engine 10. The flow of fluid 137 may therefore be provided proximate to the outer casings 110, 120 and the outer diameter at the conical portion 102 of the inner casing assembly 100 such as to transfer thermal energy to the flange 105 to reduce the thermal gradient relative to warmer radially inward portions of the inner casing assembly 100, such as indicated at inner case portions 101 (FIG. 2). As such, axial deflections between structures attached to the inner portion 101 of the inner casing assembly 100 to the outer casings 110, 120 resulting from the thermal gradient may be reduced or eliminated.

Referring now to FIG. 4, a cross sectional view at Section 4-4 in FIG. 3 is generally provided. In various embodiments, the inner casing assembly 100, the first outer casing 110, the second outer casing 120, or combinations thereof may define a groove 133 through which the flow circuit 135 is defined. In various embodiments, the flow circuit 135 defines a tuned cross sectional area based at least on a desired thermal gradient at the outer casings 110, 120 and the inner portion 101 of the inner casing assembly 100. For example, the tuned cross sectional area may define a first area and a second area different from the first area such as to generate a pressure differential within the flow circuit 135. Still further, the tuned cross sectional area may define a free vortex or forced vortex flow within the flow circuit 135. The tuned cross sectional area may therefore dispose the flow of fluid 137 within the flow circuit 135 for longer or shorter periods of time such as to enable additional transfer of thermal energy to the inner casing assembly 100 or one or more of the outer casings 110, 120, thereby adjusting or reducing the thermal gradient relative to the inner casing assembly 100, or inner portions 101 radially inward at the inner casing assembly 100.

In one embodiment, the flow circuit 135 is defined substantially circumferentially around the engine 10 at the flange 105. In still another embodiment, the flow circuit defines a plurality of discrete openings disposed in adjacent circumferential arrangement. As such, the plurality of discrete openings may define a plurality of the flow circuit 135 each disposed in adjacent circumferential arrangement. Still further, in various embodiments, the plurality of flow circuit 135 may each define different or tuned cross sectional areas relative to one another.

Although generally depicted as circular cross sections, various embodiments of the flow circuit 135 may further define one or more cross sectional areas, such as, but not limited to, circular, elliptical, racetrack or oval, polygonal, or oblong cross sections.

The embodiments of the engine 10 shown and described in regard to FIGS. 1-4 including the flow circuit 135 to promote transfer of thermal energy to the flange 105 at which the inner casing assembly 100 and the outer casings 110, 120 are attached. As such, reduction in thermal gradient between the inner portion 101 of the inner casing assembly 100 and the flange 105 via heat transfer to the flange 105 reduces a thermal gradient between the inner portion 101 of the inner casing assembly 100 and one or more of the outer casings 110, 120. By reducing the thermal gradient between the inner portion 101 of the inner casing assembly 100 and the flange 105, the structures generally provided herein reduce or eliminate deflections that alter clearances or axial overlaps between rotary and static components in the hot section, such as between the inner portion 101 of the inner casing assembly 100 and rotary components 33 of the turbine section 31.

Still further, the structures shown and described herein may alternatively, or additionally, reduce deflections between the inner portion 101 of the inner casing assembly 100 and outer casing 120 that adversely affect turbine nozzle 68 deflection or “rock” and axial immersions of the fuel nozzle 200 into or relative to the combustion chamber 62 or a surrounding swirler or vane structure. As such, reducing or eliminating changes in fuel nozzle 200 immersions (e.g., reducing or eliminating changes along the axial direction A) may mitigate combustion section auto-ignition and/or improve emissions, performance, or operability of the combustion section 26 and engine 10.

All or part of the engine 10 including various embodiments of the inner casing assembly 100, the outer casings 110, 120, the fuel nozzle 200, or the compressor section 21, the combustion section 26, and the turbine section 31 generally, may be formed as a unitary structure or a plurality of discrete structures by one or more manufacturing processes. Such processes may include, but are not limited to forgings, castings, or material removal processes such as machining, milling, turning, or cutting, or material additive processes, such as welding, brazing, or one or more additive manufacturing or 3D printing processes, or material deposition processes.

Portions of the engine 10, such as the fuel nozzle 200 relative to the second outer casing 120, the turbine section 31 relative to the second outer casing 120 and/or the inner casing assembly 100, or the flange 105, including the inner casing assembly 100, the first outer casing 110, the second outer casing 120, or combinations thereof, may each be mated together via one or more fasteners, including, but not limited to, nuts, bolts, screws, tie rods, rivets, or bonding processes, such as welding, brazing, friction bonding, or an adhesive.

Still further, various embodiments of the engine 10 described herein, or portions thereof, may include one or more surface finishing operations, such as at the flow circuit 135. Surface finishing operations may include, but are not limited to, polishing or super polishing processes, barreling or rifling, coatings, or one or more other processes to adjust a roughness or smoothness of the surface.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A turbine engine, comprising:
a first outer casing and a second outer casing coupled together at a flange, wherein the first outer casing and the second outer casing are together disposed around a core engine; and
an inner casing assembly extended from the flange between the first outer casing and the second outer casing, wherein a flow circuit is defined between the first outer casing, the inner casing assembly, and the second outer casing.

2. The turbine engine of claim 1, wherein the flow circuit is defined from radially inward of the outer casing, wherein a flow of compressed air is provided through the flow circuit.

3. The turbine engine of claim 1, wherein the inner casing assembly, the first outer casing, the second outer casing, or combinations thereof define a groove through which the flow circuit is defined.

4. The turbine engine of claim 1, wherein the first outer casing and the inner casing assembly together define a first cavity therebetween, wherein the first cavity defines a first pressure.

5. The turbine engine of claim 4, wherein the second outer casing and the inner casing assembly together define a second cavity therebetween, wherein the second cavity defines a second pressure higher than the first pressure.

6. The turbine engine of claim 5, wherein the flow circuit is extended from the second cavity to the first cavity.

7. The turbine engine of claim 5, wherein the second cavity comprises a diffuser cavity of a combustion section.

8. The turbine engine of claim 5, wherein the flow circuit provides a flow of fluid from the second cavity to the first cavity.

9. The turbine engine of claim 5, wherein the flow circuit is extended radially into the flange from the second cavity, axially into the flange, and radially through the flange into the first cavity.

10. The turbine engine of claim 1, wherein the flow circuit comprises a plurality of discrete openings.

11. The turbine engine of claim 10, wherein the engine comprises a plurality of the flow circuit each defining a discrete opening, wherein the plurality of the flow circuit are disposed in adjacent circumferential arrangement.

12. The turbine engine of claim 1, wherein the inner casing assembly comprises an inner diffuser case.

13. The turbine engine of claim 1, wherein the first outer casing comprises a compressor case.

14. The turbine engine of claim 1, wherein the second outer casing comprises an outer diffuser case.

15. The turbine engine of claim 1, wherein one or more of a combustor liner or a turbine nozzle is coupled to the inner casing assembly.

16. The turbine engine of claim 1, wherein a fuel nozzle is coupled to the second outer casing.

17. The turbine engine of claim 1, wherein the flow circuit comprises a tuned cross sectional area based at least on a desired thermal gradient between the inner casing assembly and the first outer casing and second outer casing.

18. The turbine engine of claim 1, wherein the flow circuit is extended at least partially along a circumferential direction relative to an axial centerline of the engine.

19. The turbine engine of claim 1, further comprising:
a compressor section, wherein the first outer casing is defined substantially around the compressor section.

20. The turbine engine of claim 1, further comprising:
a combustion section, wherein the second outer casing is defined substantially around the combustion section.
